(19) United States
(12) Patent Application Publication
(10) Pub. No.: US 2020/0402056 A1
(43) Pub. Date: Dec. 24, 2020

(54) MOBILE ORDERING AND PAYMENT SOLUTION BASED ON WI-FI NETWORK

(71) Applicants: ANUP BALAGOPAL, TAMPA, FL (US); VINAY PATODIA, Mumbai (IN)

(72) Inventors: ANUP BALAGOPAL, TAMPA, FL (US); VINAY PATODIA, Mumbai (IN)

(21) Appl. No.: 16/819,182

(22) Filed: Mar. 16, 2020

Related U.S. Application Data
(60) Provisional application No. 62/821,503, filed on Mar. 21, 2019.

(51) Int. Cl. G06Q 20/40; G06Q 20/32; H04L 29/12

(52) U.S. Cl. CPC G06Q 20/4015; H04L 61/6022; G06Q 20/325; G06Q 20/3224

(57) ABSTRACT

Conventionally, ordering for items at large venues with multiple concessions stands requires users to wait in line at each counter to place an order. Embodiments of present disclosure provide system to place an order from their mobile phones, without need of downloading any application. When user logins to wi-fi network, a captive portal specific to the location of user is dynamically generated wherein proximity based entities providing items for ordering are displayed. MAC address of user's mobile device is captured during registering of mobile device to Wi-Fi network. A zip code from mobile device is obtained to authenticate payment card selected on captive portal for completing transaction. The order is determined as a first order or nth order for given day and amount is computed for completing the transaction, the computed amount is specific to item and other items being processed in previous sessions of the given day.

### TECHNICAL FIELD

The embodiments herein generally relate to Wi-Fi network firewall and login technology for delivering a dynamic captive portal that enables application-less mobile ordering and payment solutions.

### BACKGROUND

Over the years, self checkout (or self-service) and payment services have grown rapidly at retail establishments. Particularly, ordering items has largely grown with an increase of users and demand for shopping for the need. Food ordering for instance, amongst many other ordering types has seen humungous attention, particularly, at small, medium and large venues. However, food, beverages and other retail concession businesses are limited to ordering manually to person at the counter leading to long lines of customers at the counter waiting to place an order. This is specifically seen during festive seasons, seasonal offer times, and the like. This adds frustration to end user who is accompanied with his family and/or friends and has shown willingness to purchase some food items.

Depending upon the infrastructure(s) type of these small, medium, and large venues and their sales statistics, entities in these venues, for example, merchandise store, eatery/restaurant, gaming/play station, shopping malls, stadiums, amusement parks, airports, stations, tend to or provide Wi-Fi options. Such options may include facilitating free Wi-Fi. However, these venues and entities in these venues are unable to monetize and attract footfalls even while providing complimentary services such as free Wi-Fi in the vicinity. On the other hand, most of branded entities or popular entities have their own native application(s) that is/are required to be installed on a computer system (or mobile communication device) to enjoy the same benefits without having to wait for in queue. Alternatively, entities have tied up with third party who provided a single application for enabling ordering across these entities for users. However, in reality, though applications are from popular or currently trending service providers, such applications have only been installed for a specific time/purpose and are further uninstalled. Other scenario is use of such applications is limited as they tend to occupy too much of memory and consume more power of the mobile device thereby degrading performance of the mobile device. Therefore, several attempts made by service providers as described above may have failed in engaging and attracting potential consumers and convert them to consumers.

### SUMMARY

In view of the foregoing, an embodiment herein provides systems and methods mobile ordering and payment solution based on Wi-Fi network. In one aspect, a processor implemented method is provided. The method comprises detecting, in a mobile communication device, at least one Wi-Fi network based on a location of the mobile communication device associated with a user; establishing a communication link between a Service Set Identifier (SSID) of the detected Wi-Fi network; dynamically generating a captive portal based on the established communication link and automatically retrieving, from a database, a set of proximity based entities; wherein the set of proximity based entities provide one or more items; obtaining a selection of at least one item associated with at least one entity from the set of proximity based entities; processing the selection at least one item for an order and rendering a payment page associated with a captive portal; obtaining a payment card information from the user upon selection of the payment card by the user in the rendered payment page associated with the captive portal and authenticating the payment card using (i) the information associated with the payment and (ii) a zip code mapped with the payment card; and generating, upon authenticating the payment card, a confirmation message indicative of completing a transaction for the at least one item being ordered.

In an embodiment, the step of establishing a communication link between a Service Set Identifier (SSID) of the detected Wi-Fi network comprises capturing a media access control (MAC) address associated with the mobile communication device and determining the user as a registered user or a first time user based on the captured MAC address.

When the user is the registered user, the method comprises: performing a comparison of the captured MAC address with a previously stored MAC address; and based on the comparison, validating, through the obtained zip code, the user and allowing the user to perform the transaction, or revoking access to a selection of payment card to refrain from performing the transaction.

In an embodiment, the method further includes periodically updating, via a notification message, a current status of the at least one item being ordered.

In an embodiment, the method further includes: determining whether an order type of the at least one item is one of (i) a first order for a current session of a given day or (ii) an nth order of the given day; computing an amount for completing the transaction based on the determined order type, wherein the computed amount is specific to at least one of (i) the at least one item and (ii) the at least one item and one or more items being processed in one or more previous sessions of the given day; and performing the transaction based on the computed amount at the end of the given day.

In another aspect, a system is provided. The system comprises a memory storing instructions; one or more communication interfaces; and one or more hardware processors communicatively coupled to said memory through said one or more communication interfaces, wherein said one or more hardware processors are configured by said instructions to: detect, in a mobile communication device, at least one Wi-Fi network based on a location of the mobile communication device associated with a user; establish a communication link between a Service Set Identifier (SSID) of the detected Wi-Fi network; dynamically generate a captive portal based on the established communication link and automatically retrieving, from a database, a set of proximity based entities, wherein the set of proximity based entities provide one or more items; obtain a selection of at least one item associated with at least one entity from the set of proximity based entities; process the selection at least one item for an order and rendering a payment page associated with a captive portal; obtain a payment card information from the user upon selection of the payment card by the user in the rendered payment page associated with the captive portal and authenticating the payment card using (i) the information associated with the payment and (ii) a zip code mapped with the payment card; and generate, upon authenticating the payment card, a confirmation message indicative of completing a transaction for the at least one item being ordered.

In an embodiment, during establishment of the communication link between the Service Set Identifier (SSID) of the detected Wi-Fi network, a media access control (MAC) address associated with the mobile communication device is captured and determining the user as a registered user or a first time user based on the captured MAC address.

In an embodiment, when the user is a registered user, said one or more hardware processors are configured by said instructions to: perform a comparison of the captured MAC address with a previously stored MAC address; and based on the comparison, validate, through the obtained zip code, the user and allowing the user to perform the transaction, or revoke access to a selection of payment card to refrain from performing the transaction.

In an embodiment, the one or more hardware processors are configured by said instructions to periodically updating, via a notification message, a current status of the at least one item being ordered.

In an embodiment, the one or more hardware processors are configured by said instructions to determine whether an order type of the at least one item is one of (i) a first order for a current session of a given day or (ii) an nth order of the given day; compute an amount for completing the transaction based on the determined order type, wherein the computed amount is specific to at least one of (i) the at least one item and (ii) the at least one item and one or more items being processed in one or more previous sessions of the given day; and perform the transaction based on the computed amount at the end of the given day.

In yet another aspect, there are provided one or more non-transitory machine readable information storage mediums comprising one or more instructions which when executed by one or more hardware processors causes: detecting, in a mobile communication device, at least one Wi-Fi network based on a location of the mobile communication device associated with a user; establishing a communication link between a Service Set Identifier (SSID) of the detected Wi-Fi network; dynamically generating a captive portal based on the established communication link and automatically retrieving, from a database, a set of proximity based entities; wherein the set of proximity based entities provide one or more items; obtaining a selection of at least one item associated with at least one entity from the set of proximity based entities; processing the selection at least one item for an order and rendering a payment page associated with a captive portal; obtaining a payment information from the user upon selection of the payment card by the user in the rendered payment page associated with the captive portal and authenticating the payment card using (i) the information associated with the payment and (ii) a zip code mapped with the payment card; and generating, upon authenticating the payment card, a confirmation message indicative of completing a transaction for the at least one item being ordered.

In an embodiment, the step of establishing a communication link between a Service Set Identifier (SSID) of the detected Wi-Fi network comprises capturing a media access control (MAC) address associated with the mobile communication device and determining the user as a registered user or a first time user based on the captured MAC address.

In an embodiment, when the user is the registered user, the one or more instructions which when executed by one or more hardware processors further cause: performing a comparison of the captured MAC address with a previously stored MAC address; and based on the comparison, validating, through the obtained zip code, the user and allowing the user to perform the transaction, or revoking access to a selection of payment card to refrain from performing the transaction.

In an embodiment, the one or more instructions which when executed by one or more hardware processors further cause periodically updating, via a notification message, a current status of the at least one item being ordered.

In an embodiment, the one or more instructions which when executed by one or more hardware processors causes: determining whether an order type of the at least one item is one of (i) a first order for a current session of a given day or (ii) an nth order of the given day; computing an amount for completing the transaction based on the determined order type, wherein the computed amount is specific to at least one of (i) the at least one item and (ii) the at least one item and one or more items being processed in one or more previous sessions of the given day; and performing the transaction based on the computed amount at the end of the given day.

Other and further aspects and features of the disclosure will be evident from reading the following detailed description of the embodiments, which are intended to illustrate, not limit, the present disclosure.

### BRIEF DESCRIPTION OF THE DRAWINGS

The embodiments herein will be better understood from the following detailed description with reference to the drawings, in which:

FIG. 1 is a block diagram illustrating a system according to an embodiment of the present disclosure;

FIG. 2 is a flow diagram illustrating a processor implemented method for performing application-less transaction using the system of FIG. 1 according to an embodiment of the present disclosure;

FIGS. 3A through 3C, depict payment processing stage for an item being ordered without saving payment card information according to an embodiment of the present disclosure;

FIGS. 3D through 3F, depict another payment processing stage for an item being ordered using saved payment card information retrieved from the captive portal according to an embodiment of the present disclosure;

FIG. 4 is a flow diagram illustrating a processor implemented method for processing an order of an item by an entity according to an embodiment of the present disclosure;

FIG. 5A depicts processing payment with or without saved payment card information according an embodiment of the present disclosure; and

FIG. 5B depicts processing of one or more items being ordered during sessions of a day according to an embodiment of the present disclosure.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

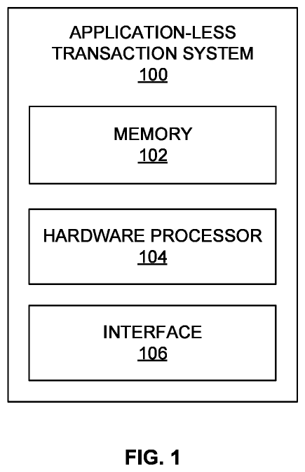

As mentioned above, users install mobile applications for ordering items and have only been installed for a specific time/purpose and are further uninstalled. Other scenario is use of such applications is limited as they tend to occupy too much of memory and consume more power of the mobile device thereby degrading performance of the mobile device. Further, not only these applications have above mentioned constraints, but request for access to services such as contacts, location, camera, etc. raising privacy and security issues. Several attempts made by service providers as described above may have failed in engaging and attracting potential consumers and convert them to consumers. Embodiments presented herein by way of non-limiting examples provide systems and methods facilitate item ordering without the need of installing an mobile applications. More specifically, when user device is in vicinity of entities (e.g., eat outs, restaurants, shopping malls) and the like, Wi-Fi network notifications may be triggered and displayed in the user device based on accessibility and availability being made by the above entity types. Upon user connecting into the Wi-Fi network, the user may be automatically navigated to a captive portal with entity list and associated items made available for ordering. The login page may act as a captive portal with entities list and display a catalogue (e.g., list of items) thereof. Further, upon selection of items for order, the orders may be processed based on payment either free delivery, paid delivery or may be requested to user to pick up the ordered item. This delivery type may be based on certain analytics in near real-time or in real-time on user historical data/current data stored in the database of the captive portal. Example of analytics may include providing discounted offers, free delivery, on the ordered item. The purchase pattern, users' viewing pattern (e.g., like, dislike, feedback provided for purchased or non-purchased items, rating provided for items listed in the captive portal, his/her navigation pattern and the like may be captured by the captive portal to learn his/her behavior of making transactions. Based on the learnt behavior by the captive portal, the portal may generate auto recommendations/suggestions and make it available when the user logs in near future for making subsequent transactions. Alternatively, notification messages may be triggered by the captive portal and transmitted to user device (e.g., at predefined intervals, and/or based on newsletter subscription activated by the user in the captive portal, or based on user profile stored in the captive portal). This methodology not only increased demand and footfalls but also eliminates the need of installing a separate item ordering application on the user device, thus providing an intuitive experience to end users. Moreover, the methodology enables enhanced security by way validating MAC address associated with user device to ensure that user is required to initiate login using same device as done in the past for navigating through captive portal and for item ordering. This further ensures that if there is a mismatch in MAC address, the user is preventing from accessing sensitive information (e.g., order history, payment card information, payment information, and the like) thus providing an additional layer of security for payments. Referring now to the drawings, and more particularly to FIGS. 1 through 5B, where similar reference characters denote corresponding features consistently throughout the figures, there are shown preferred embodiments.

FIG. 1 is a block diagram illustrating a system 100 according to an embodiment of the present disclosure. The system includes a memory 102 for storing instructions, and a hardware processor 104 configured by the instructions to perform one or more functions, for example, to login of users in a dynamically generated captive portal to perform one or more methodologies described herein. The system 100 further includes an interface 106. Although the exemplary block diagram and the associated description refer to a memory, a hardware processor, and an I/O interface, it may be understood that one or more memory units, one or more hardware processors, and one or more I/O interfaces may be included in the system 100. The memory 102 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, a compact disks (CDs), digital versatile disc or digital video disc (DVDs) and magnetic tapes. The memory 102 further includes module(s) (not shown in FIG. 1) to perform the methodologies described herein.

According to the present disclosure, the system 100 includes any computing device, for example, a multi-function device that allows a user to perform any desired functionalities related to accessing Wi-Fi network, navigating through information displayed on the captive portal, and performing one or more transactions involving for instance, purchasing one or more items displayed in the captive portal. In the context of the present disclosure, the system 100 detects a Wi-Fi network and upon selection of the detected Wi-Fi network, the user is navigated to a captive portal wherein he/she accesses the captive portal with or without providing login credentials. The Wi-Fi network may be detected by the system 100 (e.g., a mobile communication device, a laptop, a tablet PC, and the like) when the system 100 is found to be in a particular location/premise or in close proximity of the location/premise. For instance, location/premise may comprise but are not limited to shopping malls, retail outlets, movie halls/multiplexes, gaming/play stations, restaurants and the like. Upon accessing the captive portal the user may be displayed (by the system 100) one or more items that he/she is interested to know more about that can lead to a potential transaction (e.g., purchasing of an item). In an embodiment of the present disclosure, the captive portal refers to a dynamically generated page that the user of a public-access network can access (with or without login details) to view and interact with components (or items) based on access being granted.

The system 100 may also be referred to as “application-less transaction system”. The system 100 may be implemented as any of a variety of conventional computing devices, including, for example, servers, a desktop PC, a notebook or portable computer, a workstation, a mainframe computer, an entertainment device, cellular phones, smart phones, personal digital assistants (PDAs), portable computers, desktop computers, tablet computers, phablets, an internet appliance, and the like. In one example embodiment, the application-less transaction system and system may be interchangeably used herein. In one example embodiment, the system 100 may be included (or integrated) in any of the computing devices, examples of which are described above.

The memory 102 may include knowledge of past user behavior/pattern of accessing the system 100 corresponding to a particular user (or users). The system 100 may be connected to other computing systems via one or more networks. Other computing systems, for example, may include conventional computing devices as described above, internet connected devices/systems, or an external storage such as a server, or a cloud computing system.

The network may be a wireless network, a wired network, or a combination thereof. The network may also be an individual network or a collection of many such individual networks, interconnected with each other and functioning as a single large network, e.g., the Internet or an intranet. The network may be implemented as one of the different types of networks, such as intranet, local area network (LAN), wide area network (WAN), the internet, near field communication (NFC), and such. The network may either be a dedicated network or a shared network, which represents an association of the different types of networks that use a variety of protocols. Further, the network may include network devices, such as network switches, hubs, routers, HBAs, for providing a communication link between the system 100 and other connected devices/systems.

The interface 106 (also referred as I/O interface) may include a variety of software and hardware interfaces, for example, a web interface, a graphical user interface, and the like. The I/O interface 106 may allow the system 100 to interact with a user directly or through the user devices. Further, the I/O interface 106 may enable the system 100 to communicate with other computing devices, such as web servers and external data servers (not shown), or cloud computing systems. The I/O interface 106 can facilitate multiple communications within a wide variety of networks and protocol types, including wired networks, for example, LAN, cable, etc., and wireless networks, such as WLAN, cellular, or satellite. The I/O interface 106 may include one or more ports for connecting a number of devices to one another or to another server.

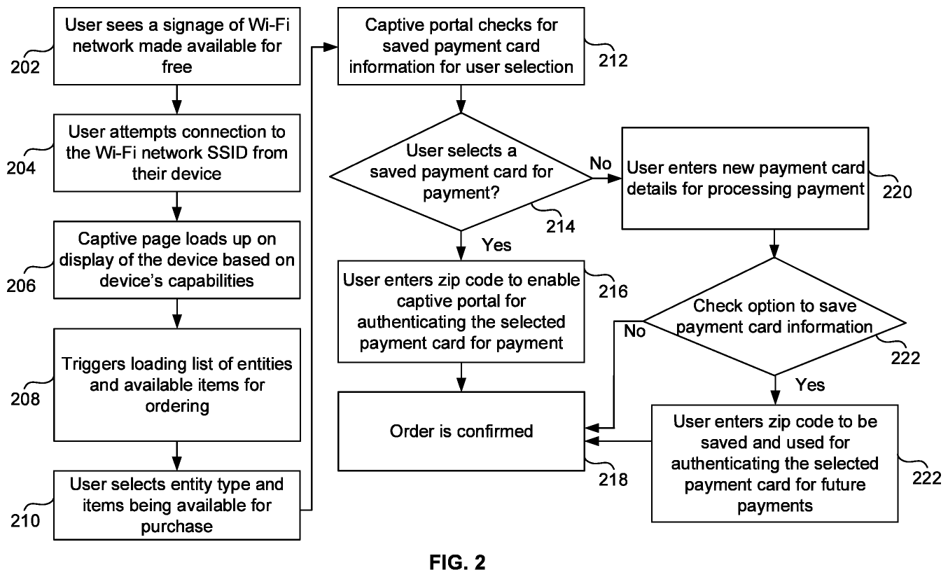

FIG. 2 in conjunction to FIG. 1, is a flow diagram illustrating a processor implemented method for performing application-less transaction using the system 100 of FIG. 1 according to an embodiment of the present disclosure. The steps of the method will now be explained in relation to the system 100 as depicted in FIG. 1, and FIG. 2. The hardware processor 104 is configured by the instructions stored in the memory 102. At step 202, the hardware processor 104 detects a Wi-Fi network being made available at a location wherein the system 100 (e.g., mobile communication device) is found. In an embodiment, the expressions mobile communication device, laptop, mobile phone, mobile device may be interchangeably used herein. Such devices to have similar or identical functionalities and/or capabilities to perform one or more methodologies described herein. For instance, the mobile communication device is associated with a user and the user may be found entering in a shopping mall. In such scenarios, the user may be displayed with signage at various point of interests (e.g., at eatery, movie ticket counter(s), play station) in the shopping mall. The signage may include information such as free Wi-Fi available. Available Wi-Fi network notifications may be triggered or detected in the mobile communication device associated with user. Such triggering or detection of Wi-Fi in the mobile communication device may be due to mobile communication device capabilities or automatic detection of location of the mobile communication device by Wi-Fi access points in the vicinity of the shopping mall. In other words, Wi-Fi access points may be placed at the various point of interests as mentioned above. At least a subset of the Wi-Fi access points may detect proximity of the mobile communication device and upon detection, Wi-Fi network notifications may be triggered and detected in the mobile communication device. Such Wi-Fi network notifications may also depend on network signal strength and modem capabilities of the associated mobile communication device. At step 204, mobile communication device initiates or attempts a communication link establishment with Service Set Identifier (SSID) of available or detected Wi-Fi network (e.g., ABC restaurant network).

At step 206, a captive portal associated with the location (or venue) may be dynamically displayed to the user or loaded on the display of the mobile communication device. For instance, in the present disclosure, assuming that the user has entered a shopping mall (e.g., say ABC shopping mall), an ABC captive portal may be dynamically displayed on the mobile communication device's screen.

At step 208, a list of proximity based entities may be displayed to the user. Alternatively, catalogue comprising one or more items that can be procured/ordered by the user from these entities are displayed on the captive portal. In an embodiment, the items displayed may comprise either paid items, items made available for free, offers on the items displayed, and the like. Offers may include, but are not limited to, special discounts, BOGO (Buy one Get one) offer, purchase one item and get discount on similar/identical item or different item, and the like. Items may include products, and/or products sold as a service, and the like. At step 210, a selection on at least one entity and/or item may be obtained from the user operating the mobile communication device. Based on the entity type, associated items may be displayed on the captive portal in the mobile communication device. For instance, for an entity type continental restaurant, continental food items may be displayed on the captive portal for ordering. The display of food items may be subject to being made available by the entity type (e.g., in this case continental restaurant) at that particular instant/time. In case, the selected food item is unavailable, the captive portal may intelligently or dynamically configure entity list, and catalogue (e.g., menu of available restaurants, eat out corners, and the like) configuration of menu based on time of day, day of week and specials of the day wherein the entities are in the vicinity of the shopping mall and may recommend or suggest the food item is available at another restaurant. One or more criteria may comprise but are not limited to, offers during certain seasons (e.g., food fest, festive season), entity accessibility, currently trending, feedback and ratings on the items and entity/entities thereof, and the like. Alternatively, the captive portal may only display items that are available in the vicinity, in one example embodiment. In such cases where only items are displayed in the captive portal upon login, the information of entities from which these items may be delivered to user (or from where user can pick up these items) may be made available during payment process or post completion of item ordering. Upon obtaining confirmation on the selection made by the user, at step 212, a payment page may be automatically rendered on the mobile communication device by the captive portal for processing the selected item for an order. During the rendering of payment page, the captive portal also checks for whether the user is already a registered user or a user who has previously accessed the captive portal or a previously visited user (e.g., in recent times, or during specific time interval). In case the user is already a registered user or a previously visited user, the captive portal checks for saved payment information (e.g., preferred payment methods that were used by the user previously to perform transactions in the past). In case the payment methods are found to be stored in a database of the captive portal, list of payment methods used by the user may be displayed for selection at step 214. When the user of the mobile communication device selects a specific payment card for performing transaction, at step 216, he/she is requested for entering zip code mapped with the payment card of the user (e.g., 45763) by the captive portal to authenticate the payment card and to confirm the payment associated with the item ordered and the item thereof by the user at step 218. During validating of user (e.g., either a first time user or previously visited user using same mobile communication device), MAC address of the mobile communication device is captured by the captive portal. Along with the MAC address of the mobile communication device, a pass code (e.g., say 6 digit pass code) may also be captured. Capturing of MAC address may be done when the user attempts to login to the Wi-Fi network(s) being made available. Since the MAC address is unique to its corresponding device (e.g., mobile communication device), the MAC address gets stored in a database/memory of the captive portal for subsequent validation of the user/mobile communication device for processing transaction. For instance, when the user saves payment card information, a card token is saved with user's mobile device and phone number. If the same user uses another mobile device to place an order (during subsequent hours or days), the captive portal invalidates the user as the MAC address does not match with the MAC address stored earlier. Upon mismatch, the captive portal may revoke user access given to the user for accessing his/her payment card information. This ensures enhanced security for the payment card information that is saved in the captive portal. It is to be understood by a person having ordinary skill in the art or person skilled in the art that though the validation or invalidation is described for MAC address and restrict user from accessing payment card information, the validation and invalidation technique can be extended to any sensitive information (e.g., customer data/profile, zip code, etc.) and the like. In other words, comparison is performed for MAC address obtained during transaction with a MAC address stored in the memory 102. Further, the user is then validated through the obtained zip code (where user is asked to enter zip code (e.g., zip code mapped with the payment card). Based on the comparison and the zip code, the user is then allowed to perform the transaction, or access is revoked for a selection of payment card to refrain from performing the transaction.

If the user is a first time user, and there are no preferred payment methods (e.g., no saved payment information available) stored in the captive portal, the user is presented with sections, wherein in the sections, the user enters payment card information or payment mode information at step 220. Upon entering the payment card information which includes the zip code information mapped with the payment card, these details may or may not be saved in the captive portal for further processing the item being ordered, at step 222. Upon saving the payment card information in the captive portal, the portal authenticates the payment card and confirm the payment associated with the item ordered by the user, at step 224 and the step 218 may be repeated which in this case the order is confirmed.

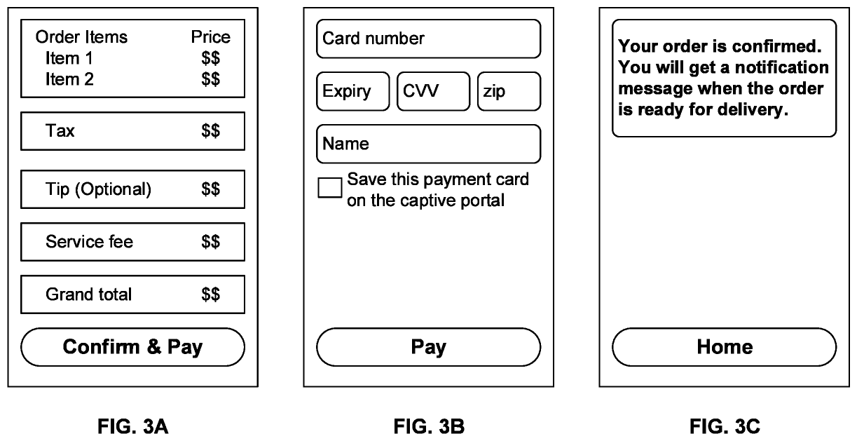

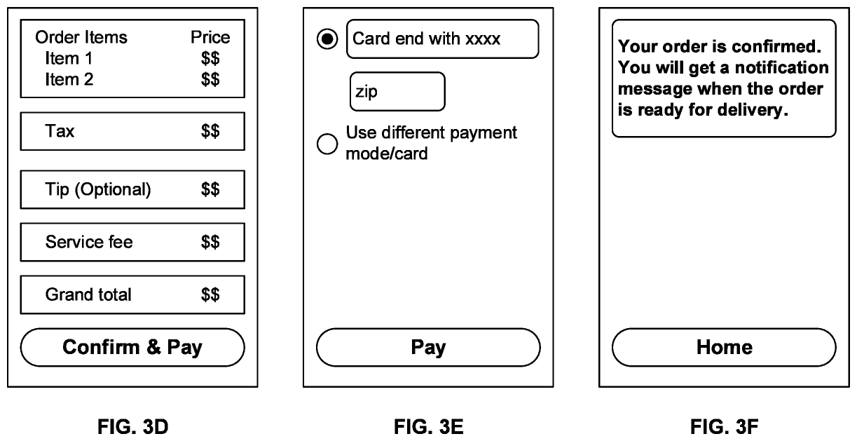

FIGS. 3A through 3C, in conjunction with FIGS. 1 and 2, depict a payment processing stage for an item being ordered according to an embodiment of the present disclosure. More specifically, FIGS. 3A through 3C, depict payment processing stage for an item being ordered without saving payment card information according to an embodiment of the present disclosure.

FIGS. 3D through 3F, in conjunction with FIGS. 1 and 2, depict another payment processing stage for an item being ordered according to an embodiment of the present disclosure. More specifically, FIGS. 3D through 3F, depict another payment processing stage for an item being ordered using saved payment card information retrieved from the captive portal according to an embodiment of the present disclosure.

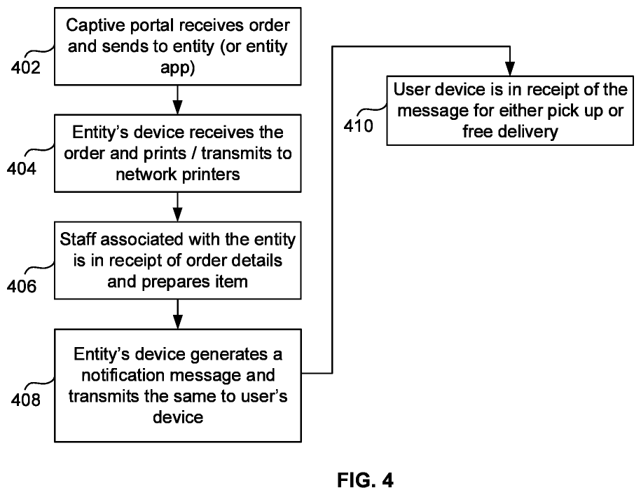

FIG. 4, in conjunction with FIGS. 1 and 3F, is a flow diagram illustrating a processor implemented method for processing an order of an item by an entity according to an embodiment of the present disclosure. More specifically, FIG. 4 depicts a back-end process of processing the order by the entity upon receiving a confirmation of item being purchased by a user. For instance, when the captive portal receives the item ordered by the user, at step 402, the captive portal communicates a message with ordered item to the entity and the entity may print order details across network printers connected within the entity at step 404. At step 406, staff associated with the entity is in receipt of the order details and prepares the ordered item in real-time or near real-time (or retrieves the ordered item if already exists for example in case of electronic product being ordered). In case of a food item, the food item may be prepared by the staff of the selected entity or an entity recommended by the captive portal upon receiving a confirm order. For merchandise type, the selected and ordered merchandise may be simply packaged for delivery. When the item is being completed for packaging, the entity portal or device associated with entity may transmit a message to the user's mobile communication device at step 408. The message may be transmitted via the captive portal to the user's mobile communication device. Further updates on ordered item(s) may be sent to user's mobile communication device at periodic intervals, in one example embodiment. Updates for example, may include, but are not limited to, food item is prepared and ready for packaging. Next update after a certain time interval (e.g., say after 2 minutes) may be a message indicative that packaging in process. Further messages may include that the item is either in transit for delivery to the user where is currently present (e.g., at the shopping mall) or the user may be requested to pick up the item from the entity based on entity's location as depicted in steps 410.

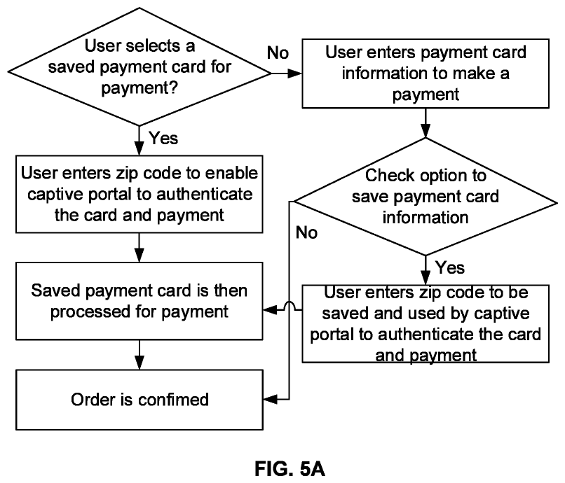

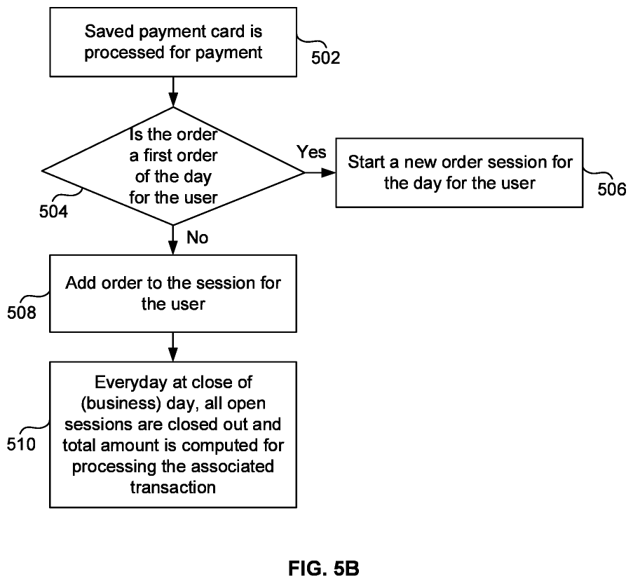

FIGS. 5A-5B, in conjunction with, FIGS. 1 to 4, is a flow diagram illustrating a processor implemented method for performing consolidated transaction of items being ordered for a given day and associated session there between according to an embodiment of the present disclosure. In particular, FIG. 5A depicts processing payment with or without saved payment card information as described in the above sections of the present disclosure and as depicted in FIGS. 3A through 3F. FIG. 5B depicts processing of one or more items being ordered during sessions of a day according to an embodiment of the present disclosure. The captive portal detects whether payment card information is processed at step 502. In scenarios where user makes a new item order or is attempting an order for the first time for a particular day, the captive portal creates a session for the user for that day for completing the transaction at steps 504 and 506 respectively. In case the new item order is not a first order (e.g., wherein there are few other orders that were being processed in a session by the captive portal), then the new item order is added to other item orders to the already created session for the user as depicted in step 508. This ensures that for a particular day, at the end of business hours, the captive portal accumulates/consolidates the item orders being made from start of the day and all open sessions are closed, thereby computing a total consolidated amount for transaction all the items initiated at each session during that particular day as depicted in step 510. In other words, multiple tabs may be kept open with multiple items for ordering that may be interest to user during a particular day, and a single transaction can be performed in the captive portal for the items selected from multiple tabs wherein a total amount may be computed for (multiple) tabs selected for items ordering. Upon computing the total consolidated amount, the transaction may be processed by the captive portal for completion for items delivery.

It is to be understood to a person having ordinary skill in the art or person skilled in the art that though the present disclosure describes items display on the captive portal for selection of items and ordering thereof, the embodiments of the present disclosure can further enable QR label/code displays along with items being displayed, or only display QR labels/code which can be scanned using a QR scanner associated with the mobile communication device for ordering associated item(s).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the disclosure.

What is claimed is:

1. A processor implemented method, comprising:
detecting, in a mobile communication device, at least one Wi-Fi network based on a location of the mobile communication device associated with a user;
establishing a communication link between a Service Set Identifier (SSID) of the detected Wi-Fi network;
dynamically generating a captive portal based on the established communication link and automatically retrieving, from a database, a set of proximity based entities, wherein the set of proximity based entities provide one or more items;
obtaining a selection of at least one item associated with at least one entity from the set of proximity based entities;
processing the selection at least one item for an order and rendering a payment page associated with a captive portal;
obtaining a payment card information from the user upon selection of the payment card by the user in the rendered payment page associated with the captive portal and authenticating the payment card using (i) the information associated with the payment and (ii) a zip code mapped with the payment card; and
generating, upon authenticating the payment card, a confirmation message indicative of completing a transaction for the at least one item being ordered.

2. The processor implemented method as claimed in claim 1, wherein the step of establishing a communication link between a Service Set Identifier (SSID) of the detected Wi-Fi network comprises capturing a media access control (MAC) address associated with the mobile communication device and determining the user as a registered user or a first time user based on the captured MAC address.

3. The processor implemented method as claimed in claim 2, wherein when the user is the registered user, the method comprises:
performing a comparison of the captured MAC address with a previously stored MAC address; and
based on the comparison,
validating, through the obtained zip code, the user and allowing the user to perform the transaction, or
revoking access to a selection of payment card to refrain from performing the transaction.

4. The processor implemented method as claimed in claim 1, further comprising periodically updating, via a notification message, a current status of the at least one item being ordered.

5. The processor implemented method as claimed in claim 1, further comprising:
determining whether an order type of the at least one item is one of (i) a first order for a current session of a given day or (ii) an nth order of the given day;
computing an amount for completing the transaction based on the determined order type, wherein the computed amount is specific to at least one of (i) the at least one item and (ii) the at least one item and one or more items being processed in one or more previous sessions of the given day; and
performing the transaction based on the computed amount at the end of the given day.

6. A system comprising:
a memory storing instructions;
one or more communication interfaces; and
one or more hardware processors communicatively coupled to said memory through said one or more communication interfaces, wherein said one or more hardware processors are configured by said instructions to:
detect, in a mobile communication device, at least one Wi-Fi network based on a location of the mobile communication device associated with a user;
establish a communication link between a Service Set Identifier (SSID) of the detected Wi-Fi network;
dynamically generate a captive portal based on the established communication link and automatically retrieving, from a database, a set of proximity based entities, wherein the set of proximity based entities provide one or more items;
obtain a selection of at least one item associated with at least one entity from the set of proximity based entities;
process the selection at least one item for an order and rendering a payment page associated with a captive portal;
obtain a payment card information from the user upon selection of the payment card by the user in the rendered payment page associated with the captive portal and authenticating the payment card using (i) the information associated with the payment and (ii) a zip code mapped with the payment card; and
generate, upon authenticating the payment card, a confirmation message indicative of completing a transaction for the at least one item being ordered.

7. The system as claimed in claim 6, wherein during establishment of the communication link between a Service Set Identifier (SSID) of the detected Wi-Fi network, a media access control (MAC) address associated with the mobile communication device is captured and determining the user as a registered user or a first time user based on the captured MAC address.

8. The system as claimed in claim 7, wherein when the user is a registered user, said one or more hardware processors are configured by said instructions to:
perform a comparison of the captured MAC address with a previously stored MAC address; and
based on the comparison,
validate, through the obtained zip code, the user and allowing the user to perform the transaction, or
revoke access to a selection of payment card to refrain from performing the transaction.

9. The system as claimed in claim 6, wherein said one or more hardware processors are configured by said instructions to periodically updating, via a notification message, a current status of the at least one item being ordered.

10. The system as claimed in claim 6, wherein said one or more hardware processors are configured by said instructions to:
determine whether an order type of the at least one item is one of (i) a first order for a current session of a given day or (ii) an nth order of the given day;
compute an amount for completing the transaction based on the determined order type, wherein the computed amount is specific to at least one of (i) the at least one item and (ii) the at least one item and one or more items being processed in one or more previous sessions of the given day; and
perform the transaction based on the computed amount at the end of the given day.

11. One or more non-transitory machine readable information storage mediums comprising one or more instructions which when executed by one or more hardware processors causes:
detecting, in a mobile communication device, at least one Wi-Fi network based on a location of the mobile communication device associated with a user;
establishing a communication link between a Service Set Identifier (SSID) of the detected Wi-Fi network;
dynamically generating a captive portal based on the established communication link and automatically retrieving, from a database, a set of proximity based entities; wherein the set of proximity based entities provide one or more items;
obtaining a selection of at least one item associated with at least one entity from the set of proximity based entities;
processing the selection at least one item for an order and rendering a payment page associated with a captive portal;
obtaining a payment card information from the user upon selection of a payment card by the user in the rendered payment page associated with the captive portal and authenticating the payment card using (i) the information associated with the payment and (ii) a zip code mapped with the payment card; and
generating, upon authenticating the payment card, a confirmation message indicative of completing a transaction for the at least one item being ordered.

12. The one or more non-transitory machine readable information storage mediums as claimed in claim 11, wherein the step of establishing a communication link between a Service Set Identifier (SSID) of the detected Wi-Fi network comprises capturing a media access control (MAC) address associated with the mobile communication device and determining the user as a registered user or a first time user based on the captured MAC address.

13. The one or more non-transitory machine readable information storage mediums as claimed in claim 12, wherein when the user is the registered user, the one or more instructions which when executed by one or more hardware processors further cause:
performing a comparison of the captured MAC address with a previously stored MAC address; and
based on the comparison,
validating, through the obtained zip code, the user and allowing the user to perform the transaction, or
revoking access to a selection of payment card to refrain from performing the transaction.

14. The one or more non-transitory machine readable information storage mediums as claimed in claim 11, wherein the one or more instructions which when executed by one or more hardware processors further cause periodically updating, via a notification message, a current status of the at least one item being ordered.

15. The one or more non-transitory machine readable information storage mediums as claimed in claim 11, wherein the one or more instructions which when executed by one or more hardware processors causes:
determining whether an order type of the at least one item is one of (i) a first order for a current session of a given day or (ii) an nth order of the given day;
computing an amount for completing the transaction based on the determined order type, wherein the computed amount is specific to at least one of (i) the at least one item and (ii) the at least one item and one or more items being processed in one or more previous sessions of the given day; and
performing the transaction based on the computed amount at the end of the given day.
